(19) United States
(12) Patent Application Publication
(10) Pub. No.: US 2021/0246371 A1
(43) Pub. Date: Aug. 12, 2021

(54) SOIL STABILIZING COMPOSITION

(71) Applicants: Hamed Niroumand, Tehran (IR); Reza Ziaie Moayed, Tehran (IR); Yasaman Zeynali, Tehran (IR)

(72) Inventors: Hamed Niroumand, Tehran (IR); Reza Ziaie Moayed, Tehran (IR); Yasaman Zeynali, Tehran (IR)

(21) Appl. No.: 17/206,620

(22) Filed: Mar. 19, 2021

Related U.S. Application Data
(60) Provisional application No. 63/075,211, filed on Sep. 7, 2020.

(51) Int. Cl. C09K 17/32; E02D 1/04; E02D 3/00

(52) U.S. Cl. CPC C09K 17/32; E02D 3/005; E02D 1/04

(57) ABSTRACT

A method for stabilizing a soil sample may include forming a Typha latifolia powder with an average particle size of between 5 nm and 150 nm by grinding Typha latifolia. The method for stabilizing the soil sample may also include mixing the Typha latifolia powder with the soil sample.

### CROSS-REFERENCE TO RELATED APPLICATION

This application claims the benefit of priority from pending U.S. Provisional Patent Application Ser. No. 63/075,211, filed on Sep. 7, 2020, and entitled “SUSPENSION FOR NANO TYPHA LATIFOLIA,” which is incorporated herein by reference in its entirety.

### TECHNICAL FIELD

The present disclosure relates to soil stabilizing compositions and particularly relates to a method for stabilizing soil.

### BACKGROUND

Soil stabilization may be a general term for any physical and chemical method of changing a natural soil to a soil with specific properties. For example, a soil stabilization process may be used to enhance shear strength and adjust the shrink-swell properties of a soil sample. A stabilized soil may be necessary for industrial processes and constructions.

One approach for soil stabilization is to add a stabilizing agent to the soil. Various materials may be used as stabilizing agents, such as synthetic and natural materials. Stabilizing agents may include cement, bitumen, calcium hydroxide, sodium chloride, calcium chloride, sodium silicate, geotextiles, and plants. However, synthetic stabilizing agents may be expensive and have a non-biodegradable nature.

On the other hand, natural stabilizing agents are renewable, low cost, and eco-friendly resources that may be used in soil stabilization. However, soil treatment by calcium-based additives may have a number of inherent disadvantages, such as carbonation, reduction of the pH value, sulfate attack, and environmental impact. Furthermore, using bitumen as a soil stabilizer may reduce shear strength and may tend to become brittle over time.

There is, therefore, a need for an eco-friendly and low cost soil stabilizing compound. There is further a need for developing a method for producing a soil stabilizing compound with high specific surface area for interaction with soil particles.

### SUMMARY

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description and the drawings.

According to one or more exemplary embodiments, the present disclosure is directed to a method for stabilizing a soil sample. In an exemplary embodiment, an exemplary method may include forming a Typha latifolia powder with an average particle size of between 5 nm and 150 nm by grinding Typha latifolia. In an exemplary embodiment, an exemplary method may further include mixing an exemplary Typha latifolia powder with an exemplary soil sample.

In an exemplary embodiment, grinding an exemplary Typha latifolia may include grinding an exemplary Typha latifolia in a ball mill. In an exemplary embodiment, an exemplary ball mill may include a plurality of balls, in which a weight ratio of Typha latifolia to exemplary plurality of balls may be between 1:15 and 1:30 (Typha latifolia:plurality of balls).

In an exemplary embodiment, grinding Typha latifolia may include grinding an exemplary Typha latifolia in an exemplary ball mill. In an exemplary embodiment, an exemplary ball mill may include a rotating ball mill rotating at a rotational speed between 600 rpm and 4200 rpm.

In an exemplary embodiment, mixing an exemplary Typha latifolia powder with an exemplary soil sample may include mixing an exemplary Typha latifolia powder with an exemplary soil sample in a weight ratio of between 1:100 and 1:0 (Typha latifolia powder:soil sample).

In an exemplary embodiment, mixing an exemplary Typha latifolia powder with an exemplary soil sample may include mixing an exemplary Typha latifolia powder with an exemplary soil sample for 10 minutes to 120 minutes.

In an exemplary embodiment, mixing an exemplary Typha latifolia powder with an exemplary soil sample may include mixing an exemplary Typha latifolia powder with an exemplary soil sample in a mixer with a rotational speed of between 70 rpm and 120 rpm.

In an exemplary embodiment, an exemplary method of stabilizing an exemplary soil sample may further include forming a suspension of an exemplary Typha latifolia powder in water. In an exemplary embodiment, an exemplary weight ratio of an exemplary Typha latifolia powder and water may be between 1:100 and 18:100 (Typha latifolia powder:water).

In an exemplary embodiment, forming an exemplary suspension of an exemplary Typha latifolia powder in water may include mixing an exemplary Typha latifolia powder and water in an ultrasonic device with an ultrasonic power of between 50 W and 300 W.

In an exemplary embodiment, forming an exemplary suspension of an exemplary Typha latifolia in water may include mixing an exemplary Typha latifolia powder and water in an exemplary ultrasonic device for between 10 minutes to 45 minutes.

In an exemplary embodiment, mixing an exemplary Typha latifolia powder with an exemplary soil sample may include mixing an exemplary Typha latifolia suspension with an exemplary soil sample in a weight ratio of between 1:100 and 18:100 (Typha latifolia suspension:soil sample).

In an exemplary embodiment, mixing an exemplary Typha latifolia powder with an exemplary soil sample may include mixing an exemplary Typha latifolia suspension with an exemplary soil sample for 1 to 15 minutes.

In an exemplary embodiment, mixing an exemplary Typha latifolia powder with an exemplary soil sample may include mixing an exemplary Typha latifolia suspension with an exemplary soil sample in a mixer with a rotational speed of between 20 rpm and 80 rpm.

According to one or more exemplary embodiments, the present disclosure is further directed to a soil stabilizing composition. In an exemplary embodiment, an exemplary soil stabilizing composition may include a Typha latifolia powder with an average particle size of between 5 nm and 150 nm.

### BRIEF DESCRIPTION OF THE DRAWINGS

The novel features which are believed to be characteristic of the present disclosure, as to its structure, organization, use and method of operation, together with further objectives and advantages thereof, will be better understood from the following drawings in which a presently preferred embodiment of the present disclosure will now be illustrated by way of example. It is expressly understood, however, that the drawings are for illustration and description only and are not intended as a definition of the limits of the present disclosure. Embodiments of the present disclosure will now be described by way of example in association with the accompanying drawings in which:

FIG. 1 illustrates a flowchart of a method for stabilizing a soil sample, consistent with one or more exemplary embodiments of the present disclosure;

FIG. 2 illustrates a scanning electron microscopy (SEM) image of a Typha latifolia powder, consistent with one or more exemplary embodiments of the present disclosure;

FIG. 3 illustrates X-ray diffraction (XRD) patterns of a Typha latifolia powder, consistent with one or more exemplary embodiments of the present disclosure; and

FIG. 4 illustrates an SEM image of a Typha latifolia powder, consistent with one or more exemplary embodiments of the present disclosure.

### DETAILED DESCRIPTION

The novel features which are believed to be characteristic of the present disclosure, as to its structure, organization, use and method of operation, together with further objectives and advantages thereof, will be better understood from the following discussion.

The present disclosure is directed to exemplary embodiments of a soil stabilizing composition. An exemplary soil stabilizing composition may include stems and flowers of a Typha latifolia plant. Typha latifolia plant is a perennial herbaceous plant. Stems and flowers of Typha latifolia plant may include subepidermal vascular and fiber bundles with enlarged epidermal cells located above each fiber bundle. Typha latifolia plant may include epidermal cells in stems covered by a continuous layer of a protective-resinous material. An exemplary protective-resinous material may contain natural polyphenolic glues, such as suberin and lignin. When exemplary polyphenolic glues are used as an exemplary soil stabilizing composition added to a soil sample, the shear strength and the compressive strength of an exemplary soil sample may increase.

An exemplary soil stabilizing composition may include at least one of a Typha latifolia powder and a Typha latifolia suspension. An exemplary Typha latifolia powder may include a nanopowder with an average particle size of between 5 nm and 150 nm. An exemplary Typha latifolia nanopowder may have a high specific surface area that may effectively interact with soil particles. An exemplary Typha latifolia nanopowder and an exemplary Typha latifolia suspension may be regarded as a suitable stabilizing agent for soil due to an inherent high energy and high specific surface area of an exemplary Typha latifolia nanopowder that may allow for a better interaction with soil particles. An exemplary Typha latifolia suspension may include nanopowder of an exemplary Typha latifolia and water.

According to one or more exemplary embodiments, the present disclosure is further directed to exemplary embodiments of a method for stabilizing a soil sample. Stems and flowers of an exemplary Typha latifolia plant may be grinded in a ball mill, such as a mixer mill. As used herein, an exemplary ball mill may include a container and a plurality of balls may be disposed inside an exemplary container. Rotational movement of an exemplary ball mill may move exemplary balls inside an exemplary ball mill. Exemplary moving balls may impact stems and flowers of an exemplary Typha latifolia plant inside an exemplary ball mill. Such impact of exemplary balls may grind stem and flowers of an exemplary Typha latifolia plant into an exemplary nanopowder with an average particle size of between 5 nm and 150 nm.

To stabilize an exemplary soil sample, an exemplary Typha latifolia powder may be mixed with an exemplary soil sample in a mixer. However, an exemplary Typha latifolia powder may also be added to an exemplary soil sample in a form of Typha latifolia suspension. An exemplary Typha latifolia suspension may be produced by dispersing an exemplary Typha latifolia powder in water. An exemplary Typha latifolia powder may be dispersed in water utilizing an ultrasonic device. An exemplary Typha latifolia suspension may be mixed with an exemplary soil sample in an exemplary mixer. Adding an exemplary Typha latifolia suspension and an exemplary Typha latifolia powder into an exemplary soil sample, such as clay and slit may enhance the shear strength and the compressive strength of an exemplary soil sample.

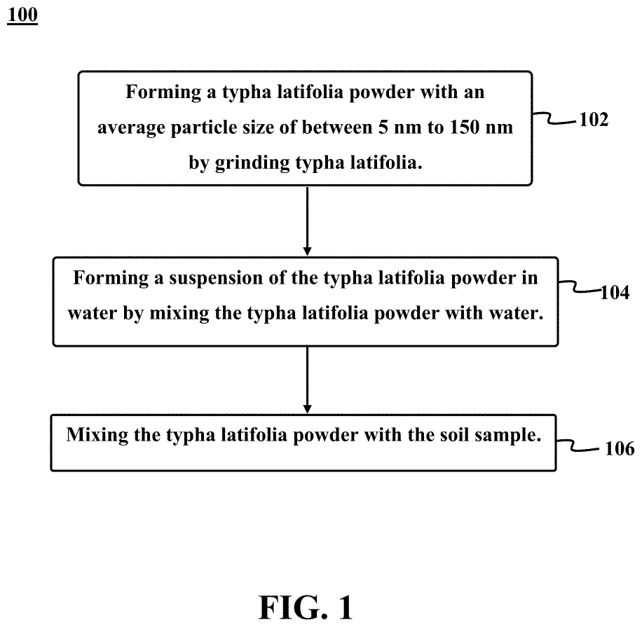

FIG. 1 illustrates a flowchart of a method 100 for stabilizing a soil sample, consistent with one or more exemplary embodiments of the present disclosure. In an exemplary embodiment, method 100 may include a step 102 of forming a Typha latifolia powder with an average particle size of between 5 nm to 150 nm by grinding Typha latifolia, a step 104 of forming a suspension of the Typha latifolia powder in water by mixing the Typha latifolia powder with water, and a step 106 of mixing the suspension of the Typha latifolia powder with the soil sample. In an exemplary embodiment, step 104 of forming a suspension of the Typha latifolia powder may be optional and an exemplary Typha latifolia powder formed in step 102 may be added directly to a soil sample.

In an exemplary embodiment, step 102 of forming the Typha latifolia powder may include grinding an exemplary Typha latifolia plant in a ball mill, such as a mixer mill. In an exemplary embodiment, an exemplary ball mill may include at least one cylindrical container and a plurality of balls that may be disposed within an exemplary cylindrical container. In an exemplary embodiment, a rotational movement of an exemplary ball mill may rotate exemplary plurality of balls and an exemplary Typha latifolia plant inside an exemplary cylindrical container. An exemplary rotational movement of an exemplary ball mill may move exemplary plurality of balls within an exemplary cylindrical container. An exemplary movement of exemplary plurality of balls may crush an exemplary Typha latifolia plant into a fine powder with an average particle size between 5 nm and 150 nm. In an exemplary embodiment, stems and flowers of an exemplary Typha latifolia plant may be used to form an exemplary Typha latifolia powder. Exemplary stems and flowers of an exemplary Typha latifolia plant and an exemplary plurality of balls may be added into an exemplary cylindrical container with a weight ratio of an exemplary Typha latifolia plant and an exemplary plurality of balls between 1:15 and 1:30 (Typha latifolia:plurality of balls). An exemplary ball mill may rotate at a rotational speed of between 600 rpm to 4200 rpm for between 15 minutes to 180 minutes to form an exemplary Typha latifolia powder with an average particle size of between 5 nm and 150 nm.

In an exemplary embodiment, an exemplary soil stabilizing compound may include at least an exemplary Typha latifolia powder or a suspension of an exemplary Typha latifolia powder in water. In an exemplary embodiment, step 104 of forming the suspension of the Typha latifolia powder in water may include mixing an exemplary Typha latifolia powder with water utilizing an ultrasonic device. An exemplary suspension may be mixed utilizing an ultrasonic device with an ultrasonic power of between 50 W and 300 W for between 10 minutes and 45 minutes to form a homogenous dispersion of an exemplary Typha latifolia powder in water. An exemplary ultrasonic device may include an ultrasonic bath and an ultrasonic probe. In an exemplary embodiment, an exemplary suspension of an exemplary Typha latifolia powder in water may have a weight ratio of between 1:100 and 18:100 (Typha latifolia powder:water). In an exemplary embodiment, step 104 of forming the suspension of the Typha latifolia powder in water may be an optional step.

In an exemplary embodiment, step 106 of mixing an exemplary suspension of Typha latifolia powder with an exemplary soil sample may include mixing an exemplary Typha latifolia suspension with an exemplary soil sample in an exemplary mixer at a rotational speed of between 20 rpm and 80 rpm for 1 to 15 minutes. In an exemplary embodiment, an exemplary Typha latifolia suspension added to an exemplary soil sample may depend on the moisture of an exemplary soil sample. In an exemplary embodiment, increase of the moisture of an exemplary soil sample may decrease the amount of an exemplary Typha latifolia suspension added to the exemplary soil sample. In an exemplary embodiment, an exemplary Typha latifolia suspension may be added to an exemplary soil sample, such as clay and slit in a weight ratio of between 1:100 and 18:100 (Typha latifolia suspension:soil).

In an exemplary embodiment, an exemplary Typha latifolia powder may be directly added to a soil sample by mixing the Typha latifolia powder from step 102 and an exemplary soil sample in a mixer. An exemplary mixer may include a container and rotating wings inside an exemplary container. An exemplary Typha latifolia powder may be mixed with an exemplary soil sample in an exemplary mixer for 10 minutes to 120 minutes at a rotational speed of between 70 rpm and 120 rpm. An exemplary Typha latifolia powder may be added to an exemplary soil sample, such as clay and slit in a weight ratio between 1:100 and 1:10 (Typha latifolia powder:soil sample). Mixing an exemplary Typha latifolia powder with an exemplary soil sample may also include adding an exemplary Typha latifolia suspension to an exemplary soil sample.

### Example 1: Producing a Soil Stabilizing Compound

In this example, a soil stabilizing compound was synthesized by a method similar to method 100. To this end, 1 g of Typha latifolia may be added to a mixer mill. The balls inside the mixer mill and Typha latifolia may have a weight ratio of 4:1 (balls: Typha latifolia). To produce a Typha latifolia powder, the mixer mill may rotate at 2400 rpm for 20 minutes. The data of the Typha latifolia grinding process is shown in Table 1, consistent with one or more exemplary embodiments of the present disclosure.

TABLE 1

| Rotating | Weight of | | |
|---|---|---|---|
| speed (rpm) | a ball (g) | Number of balls | Material |
| 2400 | 2 | 2 | typha latifolia |

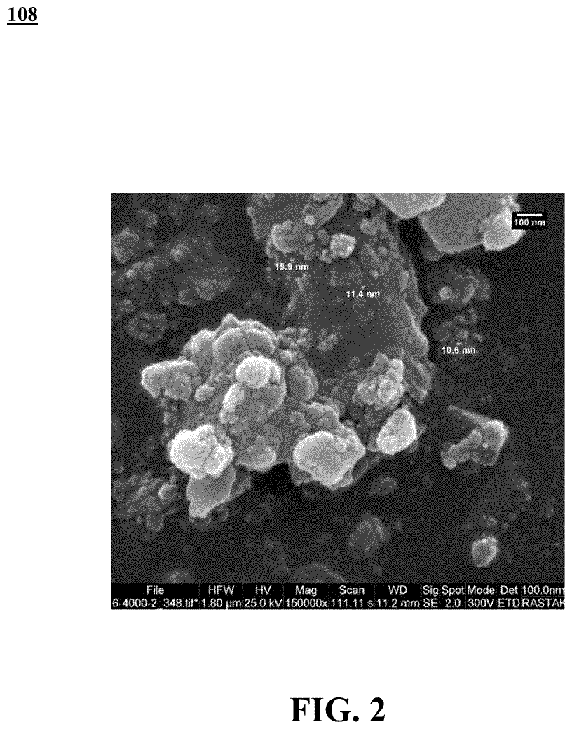

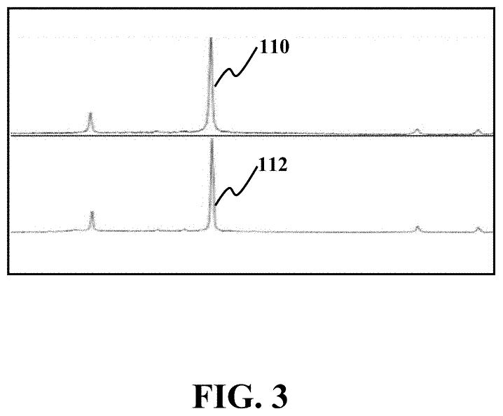

FIG. 2 illustrates a scanning electron microscopy (SEM) image 108 of the Typha latifolia powder after grinding utilizing a mixer mill, consistent with one or more exemplary embodiments of the present disclosure. As evident in FIG. 2 the average particle size of the Typha latifolia powder is between 10 nm and 15 nm. FIG. 3 illustrates X-ray diffraction (XRD) patterns of the Typha latifolia powder, consistent with one or more exemplary embodiments of the present disclosure. An XRD pattern 110 and an XRD pattern 112 show characteristic peaks of the Typha latifolia plant before the grinding process and after grinding in the mixer mill, respectively. XRD pattern 110 and XRD pattern 112 may show that Typha latifolia is not contaminated during milling.

Table 2. illustrates elemental compositions of Typha latifolia using X-ray fluorescence (XRF) analyzer, consistent with one or more exemplary embodiments of the present disclosure. XRF data is constant after milling the Typha latifolia plant, which may indicate that the Typha latifolia plant is not contaminated during milling.

TABLE 2

| Element | Na₂O | MgO | Al₂O₃ | SiO₂ | P₂O₅ | SO₃ | K₂O | CaO | TiO₂ |
|---|---|---|---|---|---|---|---|---|---|
| wt. % | 2.153 | 2.309 | « | 10.997 | 5.448 | 6.810 | 29.936 | 19.866 | « |
| Element | Fe₂O3 | V₂O₅ | MnO | Cr₂O₃ | Ni | Zn | Sr | Y | Pb |
| wt. % | 11.050 | 0.917 | 1.134 | « | « | — | — | — | — |
| Element | Ba | Zr | Cl | Co | Ce | Mo | Nb | Cu | Sn |
| wt. % | — | — | 9.379 | — | — | — | « | « | — |

### Example 2: Producing Suspensions of Typha latifolia in Water

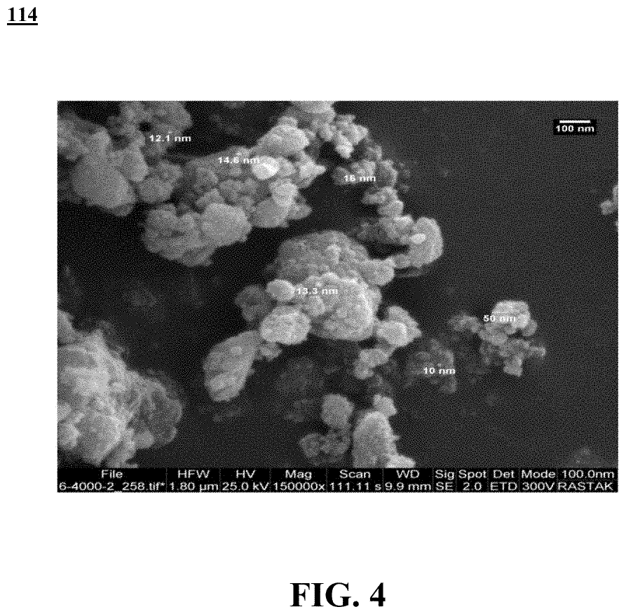

Typha latifolia suspensions may be prepared by adding the Typha latifolia powder in water. To this end, three suspensions of 3 wt. %, 5 wt. %, and 7 wt. % of the Typha latifolia powder in water may be prepared. The Typha latifolia powder may be added to water with a weight ratio of 3:100 (Typha latifolia:water) for preparing the suspension of 3 wt. % of Typha latifolia in water. In another experiment, the Typha latifolia powder may be added to water with a weight ratio of 5:100 (Typha latifolia:water) for preparing the suspension of 5 wt. % of Typha latifolia in water. For another sample, the Typha latifolia powder may be added to water with a weight ratio of 7:100 (Typha latifolia:water) for preparing the suspension of 7 wt. % of Typha latifolia in water. FIG. 4 illustrates an SEM image 114 of the Typha latifolia suspension after drying, consistent with one or more exemplary embodiment of the present disclosure. SEM image 114 may indicate nano size of Typha latifolia particles after drying.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps. Moreover, the word “substantially” when used with an adjective or adverb is intended to enhance the scope of the particular characteristic; e.g., substantially planar is intended to mean planar, nearly planar and/or exhibiting characteristics associated with a planar element. Further use of relative terms such as “vertical”, “horizontal”, “up”, “down”, and “side-to-side” are used in a relative sense to the normal orientation of the apparatus.

What is claimed is:

1. A method for stabilizing a soil sample, the method comprising:
forming a Typha latifolia powder with an average particle size of between 5 nm and 150 nm by grinding Typha latifolia in a ball mill, the ball mill comprising a plurality of balls with a weight ratio of Typha latifolia to the plurality of balls between 1:15 and 1:30 (Typha latifolia:plurality of balls);
forming a Typha latifolia suspension in water by mixing the Typha latifolia powder with water in a weight ratio of the Typha latifolia powder and water between 1:100 and 18:100 (Typha latifolia powder:water); and
mixing the Typha latifolia suspension with the soil sample in a weight ratio of between 1:100 and 1:10 (Typha latifolia suspension:soil sample).

2. A method for stabilizing a soil sample, the method comprising:
forming a Typha latifolia powder with an average particle size of between 5 nm to 150 nm by grinding Typha latifolia; and
mixing the Typha latifolia powder with the soil sample.

3. The method of claim 2, wherein grinding the Typha latifolia comprises grinding the Typha latifolia in a ball mill, wherein the ball mill comprises a plurality of balls, wherein a weight ratio of Typha latifolia to the plurality of balls is between 1:15 and 1:30 (Typha latifolia:plurality of balls).

4. The method of claim 3, wherein grinding Typha latifolia comprises grinding the Typha latifolia in the ball mill for 15 minutes to 180 minutes.

5. The method of claim 4, wherein grinding Typha latifolia comprises grinding the Typha latifolia in the ball mill, the ball mill comprising a rotating ball mill rotating at a rotational speed between 600 rpm and 4200 rpm.

6. The method of claim 2, wherein mixing the Typha latifolia powder with the soil sample comprises mixing the Typha latifolia powder with the soil sample in a weight ratio of between 1:100 and 1:10 (Typha latifolia powder:soil sample).

7. The method of claim 6, wherein mixing the Typha latifolia powder with the soil sample comprises mixing the Typha latifolia powder with the soil sample for 10 minutes to 120 minutes.

8. The method of claim 7, wherein mixing the Typha latifolia powder with the soil sample comprises mixing the Typha latifolia powder with the soil sample in a mixer with a rotational speed of between 70 rpm and 120 rpm.

9. The method of claim 2, further comprising forming a suspension of the Typha latifolia powder in water, wherein the weight ratio of the Typha latifolia powder and water is between 1:100 and 18:100 (Typha latifolia powder:water).

10. The method of claim 9, wherein forming the suspension of the Typha latifolia powder in water comprises mixing the Typha latifolia powder and water in an ultrasonic device with an ultrasonic power of between 50 W and 300 W.

11. The method of claim 10, wherein forming the suspension of the Typha latifolia powder in water comprises mixing the Typha latifolia powder and water in the ultrasonic device for between 10 minutes to 45 minutes.

12. The method of claim 11, wherein mixing the Typha latifolia powder with the soil sample comprises mixing the Typha latifolia suspension with the soil sample in a weight ratio of between 1:100 and 18:100 (Typha latifolia suspension:soil sample).

13. The method of claim 12, wherein mixing the Typha latifolia powder with the soil sample comprises mixing the Typha latifolia suspension with the soil sample for 1 to 15 minutes.

14. The method of claim 13, wherein mixing the Typha latifolia powder with the soil sample comprises mixing the Typha latifolia suspension with the soil sample in a mixer with a rotational speed of between 20 rpm and 80 rpm.

15. A soil stabilizing composition, comprising a Typha latifolia powder with an average particle size between 5 nm and 150 nm.

16. The soil stabilizing composition of claim 15, wherein the Typha latifolia powder comprises stem and flower of Typha latifolia.

17. The soil stabilizing composition of claim 16, further comprises water with a weight ratio of between 1:100 and 18:100 (Typha latifolia powder:water).

18. A soil stabilizing composition, comprising a Typha latifolia powder with an average particle size between 5 nm and 150 nm dispersed into water with a weight ratio of between 1:100 and 18:100 (Typha latifolia powder:water).
